(19) United States
(12) Patent Application Publication
(10) Pub. No.: US 2023/0103000 A1
(43) Pub. Date: Mar. 30, 2023

(54) HARDWARE MANAGED ADDRESS TRANSLATION SERVICE FOR INTEGRATED DEVICES

(71) Applicant: Intel Corporation, Santa Clara, CA (US)

(72) Inventors: Rupin Vakharwala, Hillsboro, OR (US); Prashant Sethi, Folsom, CA (US); Rajesh M. Sankaran, Portland, OR (US); Philip R. Lantz, Cornelius, OR (US); David J. Harriman, Portland, OR (US); Utkarsh Y. Kakaiya, Folsom, CA (US); Vinay Raghav, Folsom, CA (US); Ashok Raj, Portland, OR (US); Siva Bhanu Krishna Boga, Folsom, CA (US)

(73) Assignee: Intel Corporation, Santa Clara, CA (US)

(21) Appl. No.: 17/485,386

(22) Filed: Sep. 25, 2021

(51) Int. Cl. G06F 12/1027; G06F 12/0802; G06F 13/42

(52) U.S. Cl. CPC G06F 12/1027; G06F 12/0802; G06F 13/4221; G06F 2212/68; G06F 2213/0026

(57) ABSTRACT

Embodiments of apparatuses, methods, and systems for hardware manage address translation services are described. In an embodiment, an apparatus includes a first interconnect, a second interconnect, address translation hardware, a device, a translation lookaside buffer. The address translation hardware is coupled to the interconnect and is to provide a translation of a first address to a second address. The device is coupled to the first interconnect and the second interconnect and is to provide the first address to the address translation hardware through the first interconnect. The translation lookaside buffer includes an entry to store the translation, which is to be provided to the translation lookaside buffer through the first interconnect by the address translation hardware. The device is to access a system memory through the second interconnect using the second address from the entry in the translation lookaside buffer. The second interconnect is in the only path between the device and the system memory.

### FIELD OF INVENTION

The field of invention relates generally to computer architecture, and, more specifically, but without limitation, to address translation in computer systems.

### BACKGROUND

Computers and other information processing systems may include one or more subsystems or components, such as processors and input/output (I/O) devices, that may independently access a system memory. Various system capabilities, such as virtualization, may result in different views of system memory for different processors and devices. Therefore, various address translation techniques for accessing system memory have been developed.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a system according to an embodiment of the invention;

FIG. 2 is a block diagram illustrating a system according to an embodiment of the invention;

FIG. 3 is a flow diagram of a method according to an embodiment of the invention.

FIG. 4A is a block diagram illustrating both an exemplary in-order pipeline and an exemplary register renaming, out-of-order issue/execution pipeline according to embodiments of the invention;

FIG. 4B is a block diagram illustrating both an exemplary embodiment of an in-order architecture core and an exemplary register renaming, out-of-order issue/execution architecture core to be included in a processor according to embodiments of the invention;

FIG. 5 is a block diagram of a processor that may have more than one core, may have an integrated memory controller, and may have integrated graphics according to embodiments of the invention;

FIG. 6 is a block diagram of a system in accordance with one embodiment of the present invention;

FIG. 7 is a block diagram of a first more specific exemplary system in accordance with an embodiment of the present invention;

FIG. 8 is a block diagram of a second more specific exemplary system in accordance with an embodiment of the present invention; and

FIG. 9 is a block diagram of a SoC in accordance with an embodiment of the present invention.

### DETAILED DESCRIPTION

In the following description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

References to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Some embodiments may have some, all, or none of the features described for other embodiments. Moreover, such phrases are not necessarily referring to the same embodiment. When a particular feature, structure, or characteristic is described in connection with an embodiment, it is submitted that it is within the knowledge of one skilled in the art to effect such feature, structure, or characteristic in connection with other embodiments whether or not explicitly described.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, as used in descriptions of embodiments, a “I” character between terms may mean that an embodiment may include or be implemented using, with, and/or according to the first term and/or the second term (and/or any other additional terms).

Various techniques, for example, Address Translation Services (ATS), as defined by the Peripheral Component Interconnect Express (PCIe) specification, may provide for address translation, for example, from a linear, virtual, guest, or other address provided by software, a processor, or a device to a physical address of a location in a system memory. A system may include hardware, such as an I/O memory management unit (IOMMU), to perform address translation and/or remapping to support transactions between various processors, devices, and system memory. The use of embodiments may provide for greater compatibility for a system on a chip (SoC) with lower system cost and complexity, for example, in a system on a chip (SoC) that may be used in systems in which system software may or may not enable and/or manage ATS for different devices.

For example, and as further described below, a capability that may referred to as hardware managed ATS (HW-ATS) is integrated into the circuitry of a system agent and/or an IOMMU and one or more translation lookaside buffers (TLBs) of certain devices (each such device TLB may be referred to as a devTLB and each such device may be referred to as a special device), such that when system software enables address-translation in an IOMMU, the IOMMU hardware sends a message to special devices to inform them that HW-ATS is available for use. If system software does not enable ATS in the special device, then the special device can use the availability of HM-ATS and start making ATS request to the IOMMU. If such an ATS request runs into a fault, the IOMMU will report the fault to system software as if the fault occurred on a non-ATS request.

Use of embodiments may allow non-ATS capable system software to run on an SoC that includes devices that require ATS. Use of embodiments provide for building integrated devices that only one path to system memory (e.g., a non-PCIe ordered path), thus reducing area for these integrated devices. Use of embodiments may provide for building non-PCIe (e.g., ACPI) systems without system software changes to support ATS on top of the non-PCIe protocol.

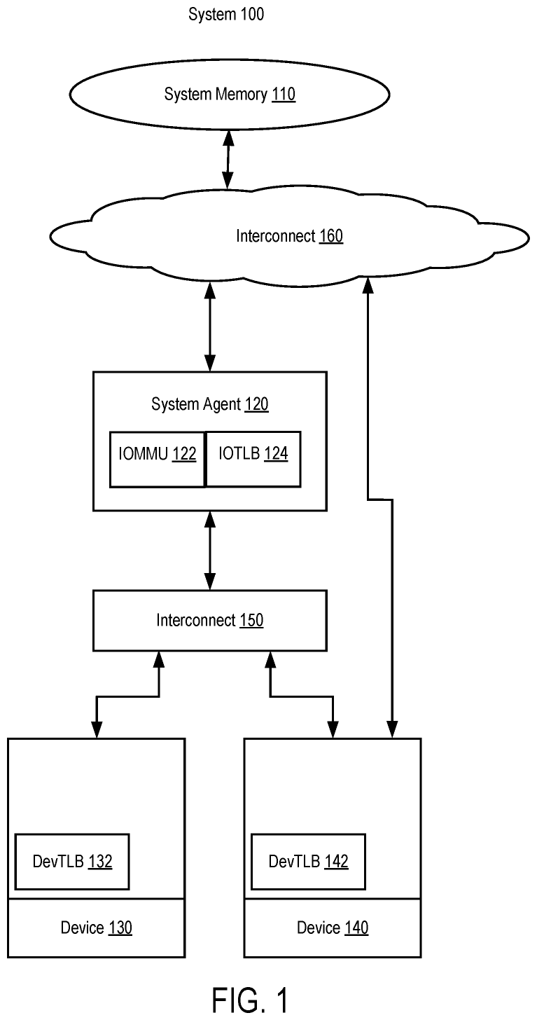

FIG. 1 is a block diagram illustrating system 100 according to an embodiment. System 100 may include system memory 110, system agent 120, device 130, device 140, interconnect 150, and interconnect 160, as well as other memories, components, interconnects, etc. not shown. System 100 and any other system embodying the invention may include any number of each of these memories, components, interconnects, etc. and any other memories, components, interconnects, etc. Any or all of the components or other elements in this or any system embodiment may be connected, coupled, or otherwise in communication with each other through any number of buses, point-to-point, or other wired or wireless interfaces or interconnects, unless specified otherwise. Any components or other portions of system 100, whether shown in FIG. 1 or not shown in FIG. 1, may be integrated or otherwise included on or in a single chip (e.g., an SOC), die, substrate, or package.

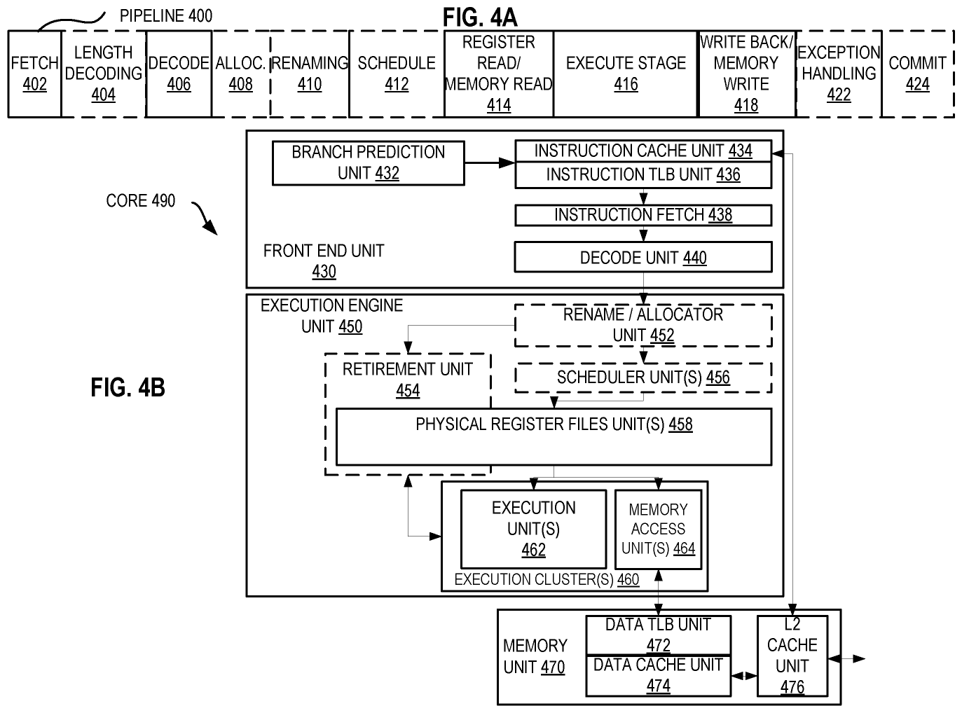

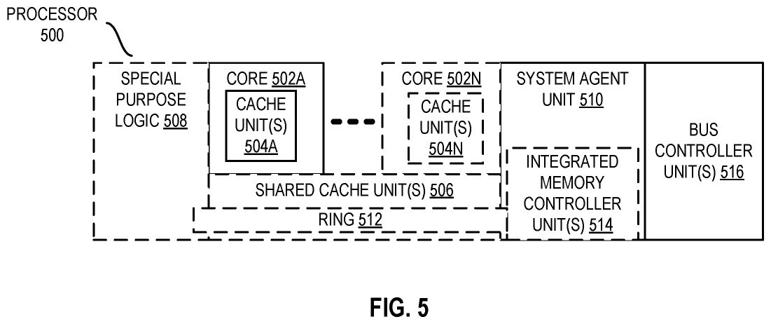

System 100 and/or any memory, component, interconnect, etc. in system 100 may correspond to a system, memory, component, interconnect, etc. shown in any of FIGS. 4 through 5, which also illustrate systems, components, etc. that may include embodiments. For example, system agent 120 and/or any or all the elements in system agent 120 may be represented by or included in system agent unit 510, controller hub 620, or chipset 790, each as described below.

System memory 110 may represent dynamic random-access memory (DRAM) or any other type of medium readable by a processor or other component. System memory 110 may be used to provide a physical memory space from which to abstract a system memory space for system 100. The content of system memory space, at various times during the operation of system 100, may include various combinations of data, instructions, code, programs, software, and/or other information stored in system memory 110 and/or moved from, moved to, copied from, copied to, and/or otherwise stored in various memories, storage devices, and/or other storage locations (e.g., processor caches and registers) in system 100.

Locations of various sizes (e.g., byte, cache line size, 4 KB or other size page, etc.) in the system memory space may be accessed and/or accessible with an address that may be referred to as a system memory address, a physical address, a host physical address, etc., any of which may be referred to in this description as a physical address. A physical address may be translated or otherwise derived from another type of address (e.g., a linear address, a virtual address, a guest address, a guest virtual address, a guest physical address) in one or more stages (e.g., two-stage translation from a guest virtual address to a guest physical address to a physical address) or other techniques, such that various software, processors, devices, etc. may use different addresses according to their different views of the system memory space (e.g., to support virtual memory, memory protection/isolation, containers, system virtualization/partitioning, etc.). Any such address translation, mapping, or other technique may be referred to in this description as address translation and may include one or more of any of a variety of techniques, types, levels, layers, rounds, and/or steps of translation, filtering, and/or processing, in any combination, using any of a variety of data structures (e.g., page tables, extended page table, nested page tables, DMA translation tables, memory access filters, memory type filters, memory permission filters, etc.) to result in a translated address (e.g., a physical address to access system memory 110) and/or in a fault, error, or any other type of determination that a requested access is not allowed. One such technique is Address Translation Services (ATS), as defined by the Peripheral Component Interconnect Express (PCIe) specification, but embodiments are not limited to ATS. Address translation may provide a translated address (e.g., a physical address) based on an untranslated address (e.g., a virtual or guest address).

System agent 120 may represent any circuitry or component, such as a root complex, including or serving as a bridge, directly or indirectly (i.e., through other circuitry or component(s)) between one or more devices and system memory according to an embodiment of the invention, to deliver, forward, translate, associate, and/or otherwise bridge transactions or other communications between a memory side of a system or sub-system and a device side. System agent 120 may be implemented in whole or in part in logic gates, storage elements, and any other type of circuitry, all or parts of which may be included in a discrete component and/or integrated into the circuitry of a processing device or any other apparatus in a computer or other information processing system.

System agent 120 may include a memory management unit, represented as input/output memory management unit (IOMMU) 122, which may further include an address translation unit, circuitry, or logic to provide address translation, e.g., as described above. To perform address translation, IOMMU 122 may use any number of page tables, extended page tables, nested page tables, or other non-hierarchical or hierarchical data structures stored in system memory 110 or elsewhere to perform any number of page walks, lookups, or other translation techniques. IOMMU 122 may also include input/output translation lookaside buffer (IOTLB) 124 to store translations generated by IOMMU 122 or otherwise useful for finding translated addresses corresponding to untranslated addresses and/or vice versa. Although shown within system agent 120, in various embodiments IOMMU 122 and/or IOTLB 124 may be and/or may be considered to be outside of and/or separate from system agent 120.

Device 130 may represent any hardware processor, co-processor, graphics processing unit (GPU), image processing unit (IPU), video processing unit (VPU), accelerator, data streaming accelerator (DSA), Intel analytics accelerator (IAX), device, agent, component, etc., or any part of such a hardware component, that may access system memory 110. Device 140 may represent any other such hardware component (e.g., a second instance of the same type as device 130, a different type of device, etc.). Each of device 130 and device 140 may include a device TLB, DevTLB 132 and DevTLB 142, respectively, to store translations generated by IOMMU 122 for device 130 and device 140, respectively.

System 100 may include any number of additional devices, each coupled or connected to system agent 120 and/or memory 110 as shown for device 130 or device 140. The architecture of system 100 may provide for device 130, device 140, and/or any other such device to be virtualized to provide one or more virtual devices and/or functions per physical device, such that the physical device may be assigned/allocated to and/or shared among multiple virtual machines, partitions, or containers (e.g., separate and/or isolated execution environments), supported by the system software, firmware, and/or hardware of system 100.

Interconnect 150 may represent any bus, interconnect, or fabric through which devices, such as devices 130 and 140, may be coupled or connected to system agent 120. Interconnect 150 may support communication between devices, such as devices 130 and 140, and system agent 120 using transactions, commands, messages, etc. according to any technique, each of which may be referred to in this description as transactions. In various embodiments, interconnect 150 may represent a fabric and/or be linked to according to an Intel On-chip System Fabric (IOSF) or other PCIe-ordered SoC fabric/interface protocol.

Interconnect 160 may represent any bus, interconnect, or fabric, through which devices, such as device 140, as well as system agent 120, may be coupled or connected to system memory 110. Interconnect 160 may support communication between devices, as well as system agent 120, and system memory 110 using transactions, commands, messages, etc. according to any technique, each of which may also be referred to in this description as transactions. In various embodiments, interconnect 160 may represent a cache-coherent fabric and/or be linked to according to a Universal Fabric Interface (UFI) or other non-PCIe-ordered SoC fabric/interface protocol.

In various embodiments, device 130 may represent a device capable of accessing system memory through a PCIe ordered path whereas device 140 may represent a device capable of accessing system memory through a non-PCIe ordered path (in some embodiments, device 140 may have only path to memory, a non-PCIe ordered path to memory, unlike, for example, a compute express link (CXL) device that may have an I/O path and a cache path to memory).

A device, such as device 130, connected to system agent 120 through interconnect 150, may access system memory 110 indirectly (i.e., through system agent 120) using untranslated addresses in transactions on interconnect 150. Different devices and different software, processes, virtual machines, containers, functions, etc. on the same or different devices may use different untranslated addresses in transactions on interconnect 150. Each of these untranslated addresses may be translated, by system agent 120 and/or IOMMU 122, or otherwise mapped or converted (e.g., by system agent 120 and/or IOMMU finding a corresponding entry in IOTLB 124) to a translated address that may be used to access system memory 110 on interconnect 160. Such a device (connected to system agent 120 through interconnect 150) may also access system memory 110 indirectly (i.e., through system agent 120) using translated addresses in transactions on interconnect 150. For these transactions, a device may use a translated address found in its DevTLB.

In contrast, other devices, such as device 140, as well as system agent 120, may access system memory 110 directly using translated addresses in transactions on interconnect 160. For these transactions, a device may use a translated address found in its DevTLB.

An address translation capability and/or protocol provided by system agent 120 and/or IOMMU 122 may be managed by system software (e.g., an operating system) or by hardware (e.g., circuitry/structures within system agent 120 and/or IOMMU 122 along with circuitry/structures within one or more DevTLBs). In some embodiments, such an address translation capability/protocol may be ATS, and although embodiments are not limited to ATS, embodiments may be described using ATS as the address translation capability/protocol. In descriptions of these embodiments, system software managed address translation may be referred to as SSM-ATS and hardware managed address translation may be referred to as HM-ATS.

If system software is aware of ATS, it may inform the IOMMU to allow ATS requests from a device (e.g., device 130 or device 140) and also enable that device to issue ATS requests. Such ATS aware system software would explicitly issue transactions to invalidate that device's DevTLB entries when corresponding page-table mappings are changed.

With HM-ATS, the hardware may enable ATS for some devices (e.g., devices, such as device 140, that may be integrated on the same SoC as the IOMMU) without system software being aware of it. For convenience but without limitation, these devices may be referred to as special devices.

When non-ATS aware system software enables address translation in the IOMMU, the IOMMU sends a message to the special device's DevTLB with two bits of information (e.g., bit 0=address translation is enabled in the IOMMU; bit 1=enable HM-ATS in the device). A list of such devices may be provided by the SoC to the IOMMU as part of a reset sequence, which may include the IOMMU waiting for an acknowledgement from all such devices that they have received the HM-ATS enable message, before completing the address translation flow and informing system software that address translation is enabled.

Although the architectural ATS (normally enabled by ATS aware system software) bit is disabled, because HM-ATS is enabled, the DevTLB will behave as if system software has enabled ATS. When such an HM-ATS request comes from a DevTLB to the IOMMU, the IOMMU operates differently than it does for SSM-ATS. With SSM-ATS, the IOMMU would block ATS requests from a DevTLB that software has not enabled. However, in HM-ATS mode, the IOMMU keeps track of devices to which it has sent a message to enable HM-ATS and will not block ATS requests from such devices. The IOMMU will also operate differently when a fault (e.g., a permission violation) is encountered on an HM-ATS request and will not report it to system software as a problem on an ATS request. Instead, the IOMMU will report it to system software as if the problem was encountered on a regular non-ATS request (i.e., an untranslated request). Operation in this way preserves the illusion for system software that ATS is off.

When system software changes page-table mappings, it will inform the IOMMU to invalidate the corresponding IOTLB entries (e.g., inside the IOMMU) by issuing one or more IOTLB-invalidation transactions. If HM-ATS is enabled for a device, since the system software has not enabled ATS, system software does not see the need to issue explicit transactions to invalidate entries in that device's DevTLB. However, because of HM-ATS, address translation information is being cached in that DevTLB and that information will be out-of-sync with address-translation tables updated by system software. Therefore, the IOMMU will convert IOTLB invalidation into appropriate DevTLB invalidations (e.g., as shown in Table 1, where a process address space identifier (PASID) corresponds to the address space associated with the transaction and may be a 20-bit tag defined by the PCIe specification and carried by the translation layer packet (TLP) prefix header of a transaction) and send them to each of the DevTLB to which it earlier sent an HM-ATS enable message.

TABLE 1

| IOTLB invalidation type | Equivalent DevTLB Invalidation |
|---|---|
| Global | Without PASID TLP; Address[63] = 1; Address |
| | [62:12] = 0; S = 1; G = 0 |
| Domain-selective | Without PASID TLP; Address[63] = 1; Address |
| | [62:12] = 0; S = 1; G = 0 (same as Global, because |
| | limited by ATS spec which does not transmit DID) |
| Page-selective within | Without PASID TLP; Address/S determined by the |
| Domain | range of pages (obtained from AM field of IOTLB |
| | invalidation) being invalidated |
| PASID-selective | With PASID TLP; Address[63:12] = don’t care; |
| | S = don’t care; G = 0 |
| PASID-selective within | With PASID TLP; Address/S determined by the |
| Domain | range of pages (obtained from AM field of IOTLB-invalidation) |
| | being invalidated |

When system software disables address translation in the IOMMU, the IOMMU will send a message with two bits of information (e.g., bit 0=address translation is disabled; bit 1=HM-ATS is disabled) to the special devices. Each device that receives this message will stop issuing new requests to memory, wait for all older requests to complete, reset its DevTLB, and then send an acknowledgement message back to the IOMMU. The IOMMU will only complete the address translation disable flow after it has received acknowledgement from each such device regarding HM-ATS disable, and then it will inform system software that address translation is disabled.

According to various embodiments, HM-ATS may be used with SSM-ATS. In these embodiments, since both hardware and system software are enabling ATS, both could issue DevTLB invalidation transactions, which is functionally correct but bad for performance due to doubling of invalidation penalty. Various embodiments may avoid this duplicate invalidation in one of at least three ways.

According to a first embodiment, hardware infers that the system software is ATS aware and will enable ATS on special devices by observing an existing configuration register that only ATS aware system software would program (e.g., scalable-mode for Intel VT-d). After such an inference, the IOMMU will not enable HM-ATS.

According to a second embodiment, the IOMMU architecture is enhanced to provide a register which system software can write to inform the IOMMU hardware that the system software is ATS aware and will enable ATS on special devices so that the IOMMU hardware should not enable HM-ATS.

According to a third embodiment, the IOMMU hardware always sends HM-ATS enable messages to special devices. When system software enables ATS in these devices, they will inform the IOMMU that system software has enabled ATS. Such information will cause the IOMMU to disable HM-ATS for the special device that sent the message. If later, system software disables ATS in that device, the device will send a message to the IOMMU to cause the IOMMU to enable HM-ATS for the device. This embodiment may have more complexity from a hardware perspective as it requires the IOMMU to keep track of the state of ATS enable/disable in special devices. Also, in this embodiment, it is possible, for a small window of time, that there is double invalidation, but that is harmless and should not have noticeable impact on performance.

In various embodiments, each special device keeping track if IOMMU has enabled HM-ATS for it may be integrated into an SoC. This state is considered the property of the SOC and not the special device. Therefore, when a reset (e.g., a Function Level Reset or FLR) occurs on the device, it does not reset any state related to HM-ATS.

In various embodiments, devices that take advantage of HM-ATS do not respond to DevTLB invalidations even when system software may put them in lower power states (e.g., D3). All state related to HM-ATS must be saved/restored across various hardware managed power-state transitions. The SoC ensures that HM-ATS related communication between the IOMMU and the DevTLB are not in-flight when starting power-management flows on the IOMMU or a DevTLB.

In various embodiments, if system software does not enable ATS, a device is expected to use untranslated addresses in transactions on the interconnect between the device and the system agent. To avoid requiring the device to have full memory bandwidth on two different interconnects (e.g., interconnects 150 and 160), the IOMMU may inform the device that address translation is not enabled and it is safe for device to use the direct interconnect to memory (e.g., interconnect 160) without ATS. If the system software does not enable address translation, then the IOMMU will not send any message to the special devices, which causes the special devices to understand that address translation is disabled and that HM-ATS is also disabled. In such a scenario, the devices will bypass their DevTLB and access memory over the direct interconnect to memory (e.g., interconnect 160) with untranslated addresses.

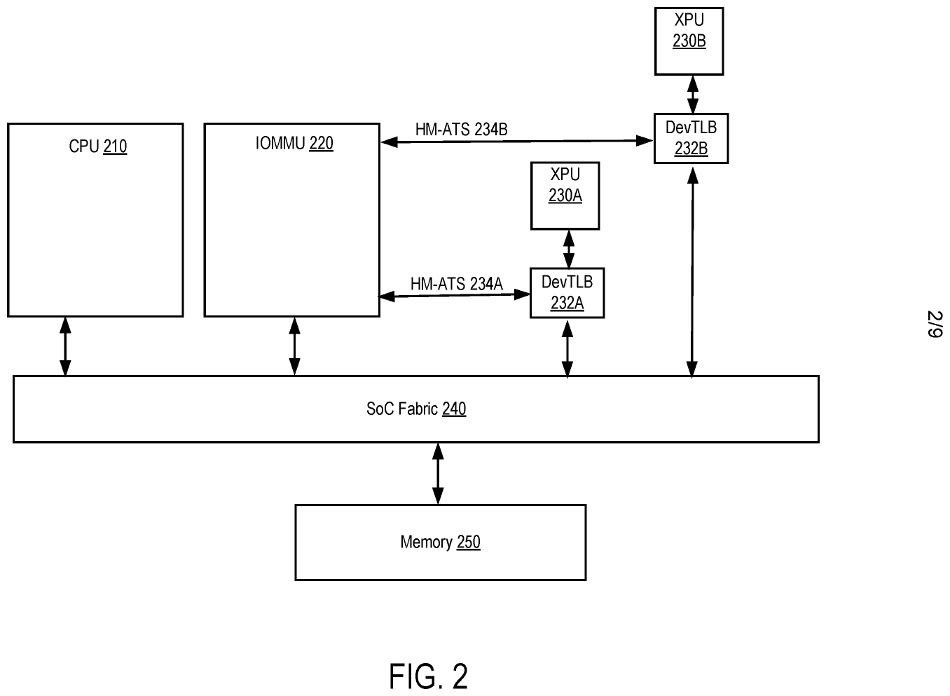

Various embodiments, for example as shown in FIG. 2, may include an IOMMU (e.g., IOMMU 210) with a wrapper and/or one or more DevTLBs (e.g., DevTLB 232A, 232B), each with a wrapper, such that devices (e.g., XPU 230A, 230B, respectively, where an XPU may represent any type of processing unit such as a GPU, IPU, VPU, DSA, IAX, etc.) and/or may be based on intellectual property (IP) cores that may be exposed to system software but do not support either the system software managed or the hardware managed address translation capability/protocol. For example, in an embodiment in which ATS is the address translation capability/protocol, it may be desired to use an XPU (e.g., AXI-based) that does not have the standard PCIe configuration space and does not support PCIe-ATS, and/or to expose the IP core to system software as an ACPI IP core. In such embodiments, the DevTLB wrapper, outside the device, allows the DevTLB to communicate with the IOMMU as if the device included a DevTLB that understands SSM-ATS and/or HM-ATS, leveraging the HM-ATS infrastructure (represented by HM-ATS 234A, 234B) instead of building a new communication protocol between the device and the IOMMU.

FIG. 2 also shows central processing unit (CPU) 210, which may be included with IOMMU 220, DevTLBs 232A and/or 232B, and XPUs 230A and/or 230B on an SoC, along with SoC fabric 240, to which CPU 210, IOMMU 220, and DevTLBs 232A/232B may be coupled or connected in order to communicate with memory 250 according to embodiments.

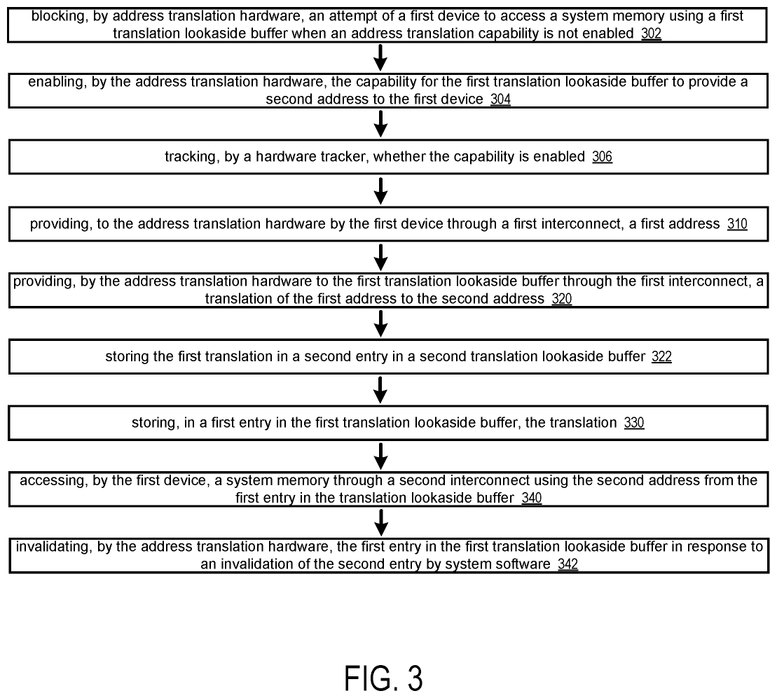

FIG. 3 is a flow diagram of a method according to an embodiment of the invention.

Block 310 represents providing, to address translation hardware (e.g., system agent 120 and/or IOMMU 122 in FIG. 1) by a first device (e.g., device 140 in FIG. 1) through a first interconnect (e.g., interconnect 150 in FIG. 1), a first address. Block 320 represents providing, by the address translation hardware to a first translation lookaside buffer (e.g., DevTLB 142 in FIG. 1) through the first interconnect, a translation of the first address to the second address. Block 330 represents storing, in a first entry in the first translation lookaside buffer, the translation. Block 340 represents accessing, by the first device, a system memory (e.g., system memory 110 in FIG. 1) through a second interconnect (e.g., interconnect 150 in FIG. 1) using the second address from the first entry in the first translation lookaside buffer; wherein the second interconnect is in the only path between the first device and the system memory.

Block 304 represents enabling, by the address translation hardware, a capability for the first translation lookaside buffer to provide the second address to the first device. Block 306 represents tracking, by a hardware tracker, whether the capability is enabled.

Block 302 represents blocking, by the address translation hardware, an attempt of the first device to access the system memory using the first translation lookaside buffer when the capability is not enabled.

Block 322 represents storing the first translation in a second entry in a second translation lookaside buffer (e.g., IOTLB 124 in FIG. 1). Block 342 represents invalidating, by the address translation hardware, the first entry in the first translation lookaside buffer in response to an invalidation of the second entry by system software.

### Exemplary Core Architectures, Processors, and Computer Architectures

The figures below detail exemplary architectures and systems to implement embodiments of the above.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

FIG. 4A is a block diagram illustrating both an exemplary in-order pipeline and an exemplary register renaming, out-of-order issue/execution pipeline according to embodiments of the invention. FIG. 4B is a block diagram illustrating both an exemplary embodiment of an in-order architecture core and an exemplary register renaming, out-of-order issue/execution architecture core to be included in a processor according to embodiments of the invention. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

FIG. 4B shows processor core 490 including a front-end unit 430 coupled to an execution engine unit 450, and both are coupled to a memory unit 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front-end unit 430 includes a branch prediction unit 432, which represents a branch prediction unit or branch predictor according to an embodiment of the present invention, such as branch predictor 100 of FIG. 1.

Branch prediction unit 432 is coupled to an instruction cache unit 434, which is coupled to an instruction translation lookaside buffer (TLB) 436, which is coupled to an instruction fetch unit 438, which is coupled to a decode unit 440. The decode unit 440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode unit 440 or otherwise within the front-end unit 430). The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations, central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 458 comprises a vector registers unit, a write mask registers unit, and a scalar registers unit. These register units may provide architectural vector registers, vector mask registers, and general-purpose registers. The physical register file(s) unit(s) 458 is overlapped by the retirement unit 454 to illustrate various ways in which register renaming and out-of-order execution may be implemented (e.g., using a reorder buffer(s) and a retirement register file(s); using a future file(s), a history buffer(s), and a retirement register file(s); using a register map and a pool of registers; etc.). The retirement unit 454 and the physical register file(s) unit(s) 458 are coupled to the execution cluster(s) 460. The execution cluster(s) 460 includes a set of one or more execution units 462 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one exemplary embodiment, the memory access units 464 may include a load unit, a store address unit, and a store data unit, each of which is coupled to the data TLB unit 472 in the memory unit 470. The instruction cache unit 434 is further coupled to a level 2 (L2) cache unit 476 in the memory unit 470. The L2 cache unit 476 is coupled to one or more other levels of cache and eventually to a main memory.

By way of example, the exemplary register renaming, out-of-order issue/execution core architecture may implement the pipeline 400 as follows: 1) the instruction fetch 438 performs the fetch and length decoding stages 402 and 404; 2) the decode unit 440 performs the decode stage 406; 3) the rename/allocator unit 452 performs the allocation stage 408 and renaming stage 410; 4) the scheduler unit(s) 456 performs the schedule stage 412; 5) the physical register file(s) unit(s) 458 and the memory unit 470 perform the register read/memory read stage 414; the execution cluster 460 perform the execute stage 416; 6) the memory unit 470 and the physical register file(s) unit(s) 458 perform the write back/memory write stage 418; 7) various units may be involved in the exception handling stage 422; and 8) the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 434/474 and a shared L2 cache unit 476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5 is a block diagram of a processor 500 that may have more than one core, may have an integrated memory controller, and may have integrated graphics according to embodiments of the invention. The solid lined boxes in FIG. 5 illustrate a processor 500 with a single core 502A, a system agent 510, a set of one or more bus controller units 516, while the optional addition of the dashed lined boxes illustrates an alternative processor 500 with multiple cores 502A-N, a set of one or more integrated memory controller unit(s) 514 in the system agent unit 510, and special purpose logic 508.

Thus, different implementations of the processor 500 may include: 1) a CPU with the special purpose logic 508 being integrated graphics and/or scientific (throughput) logic (which may include one or more cores), and the cores 502A-N being one or more general purpose cores (e.g., general purpose in-order cores, general purpose out-of-order cores, a combination of the two); 2) a coprocessor with the cores 502A-N being a large number of special purpose cores intended primarily for graphics and/or scientific (throughput); and 3) a coprocessor with the cores 502A-N being a large number of general purpose in-order cores. Thus, the processor 500 may be a general-purpose processor, coprocessor, or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 506, and external memory (not shown) coupled to the set of integrated memory controller units 514. The set of shared cache units 506 may include one or more mid-level caches, such as level 2 (L2), level 3 (L3), level 4 (L4), or other levels of cache, a last level cache (LLC), and/or combinations thereof. While in one embodiment a ring-based interconnect unit 512 interconnects the integrated graphics logic 508 (integrated graphics logic 508 is an example of and is also referred to herein as special purpose logic), the set of shared cache units 506, and the system agent unit 510/integrated memory controller unit(s) 514, alternative embodiments may use any number of well-known techniques for interconnecting such units. In one embodiment, coherency is maintained between one or more cache units 506 and cores 502-A-N.

In some embodiments, one or more of the cores 502A-N are capable of multi-threading. The system agent 510 includes those components coordinating and operating cores 502A-N. The system agent unit 510 may include for example a power control unit (PCU) and a display unit. The PCU may be or include logic and components needed for regulating the power state of the cores 502A-N and the integrated graphics logic 508. The display unit is for driving one or more externally connected displays.

The cores 502A-N may be homogenous or heterogeneous in terms of architecture instruction set; that is, two or more of the cores 502A-N may be capable of execution the same instruction set, while others may be capable of executing only a subset of that instruction set or a different instruction set.

### Exemplary Computer Architectures

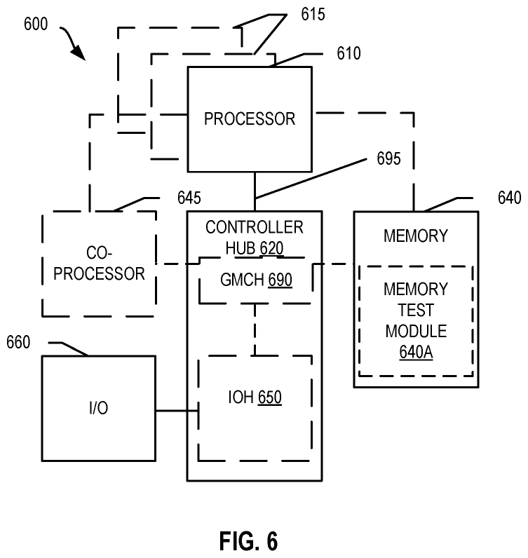

FIGS. 6-9 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, handheld devices, and various other electronic devices, are also suitable. In general, a huge variety of systems or electronic devices capable of incorporating a processor and/or other execution logic as disclosed herein are generally suitable.

Referring now to FIG. 6, shown is a block diagram of a system 600 in accordance with one embodiment of the present invention. The system 600 may include one or more processors 610, 615, which are coupled to a controller hub 620. In one embodiment, the controller hub 620 includes a graphics memory controller hub (GMCH) 690 and an Input/Output Hub (IOH) 650 (which may be on separate chips); the GMCH 690 includes memory and graphics controllers to which are coupled memory 640 and a coprocessor 645; the IOH 650 couples input/output (I/O) devices 660 to the GMCH 690. Alternatively, one or both of the memory and graphics controllers are integrated within the processor (as described herein), the memory 640 and the coprocessor 645 are coupled directly to the processor 610, and the controller hub 620 in a single chip with the IOH 650.

The optional nature of additional processors 615 is denoted in FIG. 6 with broken lines. Each processor 610, 615 may include one or more of the processing cores described herein and may be some version of the processor 500.

The memory 640 may be, for example, dynamic random-access memory (DRAM), phase change memory (PCM), or a combination of the two. For at least one embodiment, the controller hub 620 communicates with the processor(s) 610, 615 via a multi-drop bus, such as a frontside bus (FSB), point-to-point interface such as QuickPath Interconnect (QPI), or similar connection 695.

In one embodiment, the coprocessor 645 is a special-purpose processor, such as, for example, a high-throughput MIC processor, a network or communication processor, compression engine, graphics processor, GPGPU, embedded processor, or the like. In one embodiment, controller hub 620 may include an integrated graphics accelerator.

There can be a variety of differences between the physical resources 610, 615 in terms of a spectrum of metrics of merit including architectural, microarchitectural, thermal, power consumption characteristics, and the like.

In one embodiment, the processor 610 executes instructions that control data processing operations of a general type. Embedded within the instructions may be coprocessor instructions. The processor 610 recognizes these coprocessor instructions as being of a type that should be executed by the attached coprocessor 645. Accordingly, the processor 610 issues these coprocessor instructions (or control signals representing coprocessor instructions) on a coprocessor bus or other interconnect, to coprocessor 645. Coprocessor(s) 645 accept and execute the received coprocessor instructions.

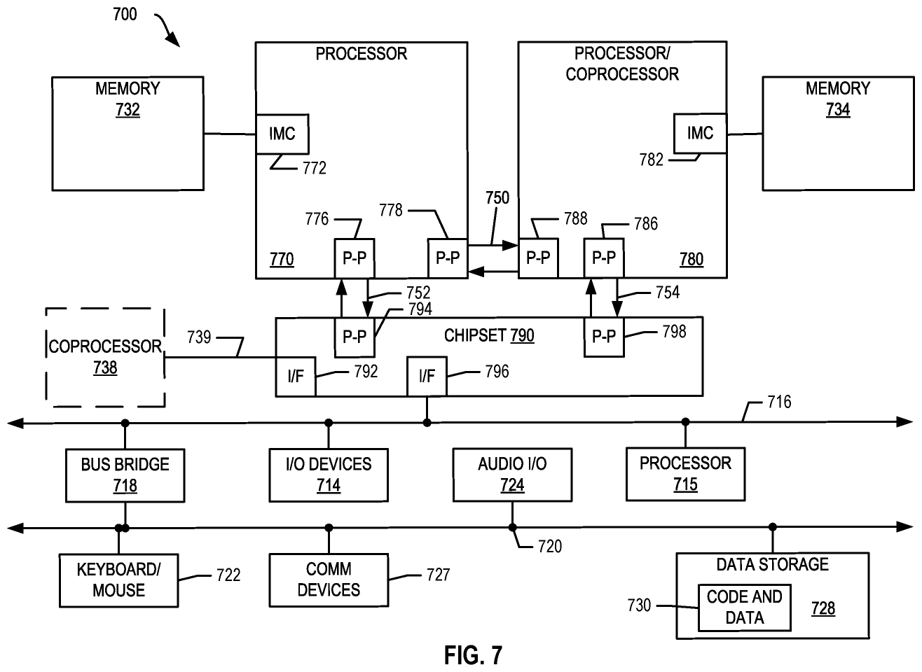

Referring now to FIG. 7, shown is a block diagram of a first more specific exemplary system 700 in accordance with an embodiment of the present invention. As shown in FIG. 7, multiprocessor system 700 is a point-to-point interconnect system, and includes a first processor 770 and a second processor 780 coupled via a point-to-point interconnect 750. Each of processors 770 and 780 may be some version of the processor 500. In one embodiment of the invention, processors 770 and 780 are respectively processors 610 and 615, while coprocessor 738 is coprocessor 645. In another embodiment, processors 770 and 780 are respectively processor 610 coprocessor 645.

Processors 770 and 780 are shown including integrated memory controller (IMC) units 772 and 782, respectively. Processor 770 also includes as part of its bus controller unit's point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may optionally exchange information with the coprocessor 738 via a high-performance interface 792. In one embodiment, the coprocessor 738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present invention is not so limited.

As shown in FIG. 7, various I/O devices 714 may be coupled to first bus 716, along with a bus bridge 718 which couples first bus 716 to a second bus 720. In one embodiment, one or more additional processor(s) 715, such as coprocessors, high-throughput MIC processors, GPGPU's, accelerators (such as, e.g., graphics accelerators or digital signal processing (DSP) units), field programmable gate arrays, or any other processor, are coupled to first bus 716. In one embodiment, second bus 720 may be a low pin count (LPC) bus. Various devices may be coupled to a second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to the second bus 720. Note that other architectures are possible. For example, instead of the point-to-point architecture of FIG. 7, a system may implement a multi-drop bus or other such architecture.

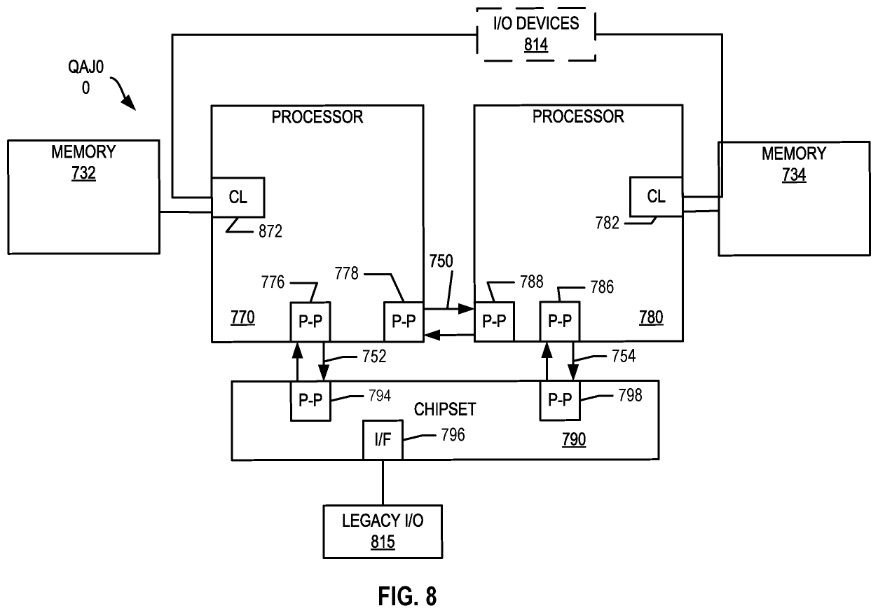

Referring now to FIG. 8, shown is a block diagram of a second more specific exemplary system 800 in accordance with an embodiment of the present invention. Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processors 770, 780 may include integrated memory and I/O control logic (“CL”) 772 and 782, respectively. Thus, the CL 772, 782 include integrated memory controller units and include I/O control logic. FIG. 8 illustrates that not only are the memories 732, 734 coupled to the CL 772, 782, but also that I/O devices 814 are also coupled to the control logic 772, 782. Legacy I/O devices 815 are coupled to the chipset 790.

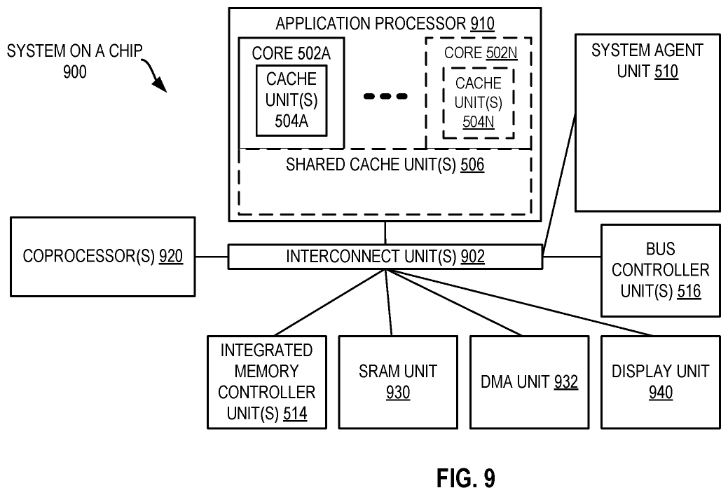

Referring now to FIG. 9, shown is a block diagram of a SoC 900 in accordance with an embodiment of the present invention. Similar elements in FIG. 5 bear like reference numerals. Also, dashed lined boxes are optional features on more advanced SoCs. In FIG. 9, an interconnect unit(s) 902 is coupled to: an application processor 910 which includes a set of one or more cores 502A-N, which include cache units 504A-N, and shared cache unit(s) 506; a system agent unit 510; a bus controller unit(s) 516; an integrated memory controller unit(s) 514; a set or one or more coprocessors 920 which may include integrated graphics logic, an image processor, an audio processor, and a video processor; an static random access memory (SRAM) unit 930; a direct memory access (DMA) unit 932; and a display unit 940 for coupling to one or more external displays. In one embodiment, the coprocessor(s) 920 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 730 illustrated in FIG. 7, may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### ADDITIONAL EXAMPLES

Some embodiments may be described in view of the following examples:
Example 1. An apparatus comprising:

a first interconnect;

a second interconnect;

address translation hardware, coupled to the first interconnect, to provide a first translation of a first address to a second address;

a first device, coupled to the first interconnect and the second interconnect, to provide the first address to the address translation hardware through the first interconnect; and

a first translation lookaside buffer including a first entry to store the first translation, the first translation to be provided to the first translation lookaside buffer through the first interconnect by the address translation hardware.

wherein the first device is to access a system memory through the second interconnect using the second address from the first entry in the first translation lookaside buffer;

the second interconnect is in the only path between the first device and the system memory.
Example 2. The apparatus of example 1, wherein the address translation hardware is to enable a capability for the first translation lookaside buffer to provide the second address to the first device.
Example 3. The apparatus of example 2, further comprising a hardware tracker to track whether the capability is enabled.
Example 4. The apparatus of example 3, wherein the address translation hardware is to block an attempt of the first device to access the system memory using the first translation lookaside buffer when the capability is not enabled.
Example 5. The apparatus of example 1, further comprising a second translation lookaside buffer having a second entry to store the first translation, wherein the address translation hardware is to invalidate the first entry in the first translation lookaside buffer in response to an invalidation of the second entry by system software.
Example 6. The apparatus of example 1, wherein the address translation hardware is to provide Address Translation Services (ATS) as defined by the Peripheral Component Interconnect Express (PCIe) specification.
Example 7. The apparatus of example 6, wherein the first interconnect is a PCIe-ordered interconnect.
Example 8. The apparatus of example 7, wherein the second interconnect is a non-PCIe-ordered interconnect.
Example 9. The apparatus of example 1, further comprising a second device, wherein:

the second device is to provide a third address to the address translation hardware;

the address translation hardware is to provide a second translation of the third address to a fourth address; and

the second device is to access the system memory using the fourth address.
Example 10. The apparatus of example 9, wherein the first interconnect is in the only path between the second device and the system memory.
Example 11. The apparatus of example 1, wherein the second address is a physical address and the first address is a linear, virtual, or guest address.
Example 12. The apparatus of example 1, wherein the apparatus is a system on a chip (SoC).
Example 13. A method comprising:

providing, to address translation hardware by a first device through a first interconnect, a first address;

providing, by the address translation hardware to a first translation lookaside buffer through the first interconnect, a translation of the first address to the second address;

storing, in a first entry in the first translation lookaside buffer, the translation; and

accessing, by the first device, a system memory through a second interconnect using the second address from the first entry in the first translation lookaside buffer;

wherein the second interconnect is in the only path between the first device and the system memory.
Example 14. The method of example 12, further comprising enabling, by the address translation hardware, a capability for the first translation lookaside buffer to provide the second address to the first device.
Example 15. The method of example 14, further comprising tracking, by a hardware tracker, whether the capability is enabled.
Example 16. The method of example 15, further comprising blocking, by the address translation hardware, an attempt of the first device to access the system memory using the first translation lookaside buffer when the capability is not enabled.
Example 17. The method of example 13, further comprising:

storing the first translation in a second entry in a second translation lookaside buffer; and invalidating, by the address translation hardware, the first entry in the first translation

lookaside buffer in response to an invalidation of the second entry by system software.
Example 18. The method of example 13, wherein the address translation hardware provides Address Translation Services (ATS) as defined by the Peripheral Component Interconnect Express (PCIe) specification.
Example 19. A system comprising:
a system memory; and
a system on a chip including:

a first interconnect;

a second interconnect;

address translation hardware, coupled to the first interconnect, to provide a first translation of a first address to a second address;

a first device, coupled to the first interconnect and the second interconnect, to provide the first address to the address translation hardware through the first interconnect; and

a first translation lookaside buffer including a first entry to store the first translation, the first translation to be provided to the first translation lookaside buffer through the first interconnect by the address translation hardware;

wherein the first device is to access the system memory through the second interconnect using the second address from the first entry in the translation lookaside buffer;

the second interconnect is in the only path between the first device and the system memory.
Example 20. The system of example 19, wherein the address translation hardware is to provide Address Translation Services (ATS) as defined by the Peripheral Component Interconnect Express (PCIe) specification.

In various embodiment, an apparatus may comprise a data storage device that stores code that when executed by a hardware processor causes the hardware processor to perform any method described above, an apparatus may be as described above, a method may be as described above, and/or a system may be as described above.

1. An apparatus comprising:
a first interconnect;
a second interconnect;
address translation hardware, coupled to the first interconnect, to provide a first translation of a first address to a second address;
a first device, coupled to the first interconnect and the second interconnect, to provide the first address to the address translation hardware through the first interconnect; and
a first translation lookaside buffer including a first entry to store the first translation, the first translation to be provided to the first translation lookaside buffer through the first interconnect by the address translation hardware;
wherein the address translation hardware is to enable a capability for the first translation lookaside buffer to provide the second address to the first device, and
the first device is to access a system memory through the second interconnect using the second address from the first entry in the first translation lookaside buffer.

2. The apparatus of claim 1, wherein the second interconnect is in the only path between the first device and the system memory.

3. The apparatus of claim 1, further comprising a hardware tracker to track whether the capability is enabled.

4. The apparatus of claim 3, wherein the address translation hardware is to block an attempt of the first device to access the system memory using the first translation lookaside buffer when the capability is not enabled.

5. The apparatus of claim 1, wherein the first translation lookaside buffer is a device translation lookaside buffer, further comprising an input/output a translation lookaside buffer having a second entry to store the first translation, wherein the address translation hardware is to invalidate the first entry in the first translation lookaside buffer in response to an invalidation of the second entry by system software.

6. The apparatus of claim 1, wherein the address translation hardware is to provide Address Translation Services (ATS) as defined by the Peripheral Component Interconnect Express (PCIe) specification.

7. The apparatus of claim 6, wherein the first interconnect is a PCIe-ordered interconnect.

8. The apparatus of claim 7, wherein the second interconnect is a non-PCIe-ordered interconnect.

9. The apparatus of claim 1, further comprising a second device, wherein:
the second device is to provide a third address to the address translation hardware;
the address translation hardware is to provide a second translation of the third address to a fourth address; and
the second device is to access the system memory using the fourth address.

10. The apparatus of claim 9, wherein the first interconnect is in the only path between the second device and the system memory.

11. The apparatus of claim 1, wherein the second address is a physical address and the first address is a linear, virtual, or guest address.

12. The apparatus of claim 1, wherein the apparatus is a system on a chip (SoC).

13. A method comprising:
enabling, by address translation hardware, a capability for a first translation lookaside buffer to provide a second address to a device;
providing, to the address translation hardware by the first device through a first interconnect, a first address;
providing, by the address translation hardware to the first translation lookaside buffer through the first interconnect, a translation of the first address to the second address;
storing, in a first entry in the first translation lookaside buffer, the translation; and
accessing, by the first device, a system memory through a second interconnect using the second address from the first entry in the first translation lookaside buffer.

14. The method of claim 13, wherein the second interconnect is in the only path between the first device and the system memory.

15. The method of claim 13, further comprising tracking, by a hardware tracker, whether the capability is enabled.

16. The method of claim 15, further comprising blocking, by the address translation hardware, an attempt of the first device to access the system memory using the first translation lookaside buffer when the capability is not enabled.

17. The method of claim 13, wherein the first translation lookaside buffer is a device translation lookaside buffer, further comprising:
storing the first translation in a second entry in an input/output translation lookaside buffer; and
invalidating, by the address translation hardware, the first entry in the first translation lookaside buffer in response to an invalidation of the second entry by system software.

18. The method of claim 13, wherein the address translation hardware provides Address Translation Services (ATS) as defined by the Peripheral Component Interconnect Express (PCIe) specification.

19. A system comprising:
a system memory; and
a system on a chip including:
a first interconnect;
a second interconnect;
address translation hardware, coupled to the first interconnect, to provide a first translation of a first address to a second address;
a first device, coupled to the first interconnect and the second interconnect, to provide the first address to the address translation hardware through the first interconnect; and
a first translation lookaside buffer including a first entry to store the first translation, the first translation to be provided to the first translation lookaside buffer through the first interconnect by the address translation hardware;
wherein the address translation hardware is to enable a capability for the first translation lookaside buffer to provide the second address to the first device, and
the first device is to access a system memory through the second interconnect using the second address from the first entry in the first translation lookaside buffer.

20. The system of claim 19, wherein the address translation hardware is to provide Address Translation Services (ATS) as defined by the Peripheral Component Interconnect Express (PCIe) specification.
